(19) United States
(12) Patent Application Publication
(10) Pub. No.: US 2020/0199388 A1
(43) Pub. Date: Jun. 25, 2020

(54) Ink Composition for Inkjet Printing

(71) Applicant: Domino Printing Sciences Plc, Cambridge Cambridgeshire (GB)

(72) Inventors: Andrew Kyriacou, Cambridge Cambridgeshire (GB); Josephine Harries, Cambridge Cambridgeshire (GB); Patricia Fortes De Andrade, Cambridge Cambridgeshire (GB)

(21) Appl. No.: 16/613,012

(22) PCT Filed: May 11, 2018
(86) PCT No.: PCT/EP2018/062229

§ 371 Date: Nov. 12, 2019

(30) Foreign Application Priority Data
May 12, 2017 (GB) 1707685.2

(51) Int. Cl. C09D 11/36; C09D 11/14; C09D 11/03; B41M 5/00

(52) U.S. Cl. CPC C09D 11/36; B41M 5/0023; C09D 11/03; C09D 11/14

(57) ABSTRACT

Disclosed is an ink composition comprising one or more volatile organic solvents and one or more colourants. The ink composition includes a binder resin having one or more polymers and a metal crosslinker for cross linking the polymers of the binder resin. The one or more polymers contain coordinating groups for cross linking the polymers of the main binder resin with the metal crosslinker. The ink composition is useful in inkjet printing such as continuous inkjet printing, and may be suitable for producing durable codes on substrates which undergo industrial retort and sterilisation processes. The ink may also provide thermal stability and reliability in the printer.

### RELATED APPLICATION

The present case claims priority to, and the benefit of, GB 1707685.2 filed on 12 May 2017, the contents of which are hereby incorporated by reference in their entirety.

### FIELD OF THE INVENTION

The present invention relates to an ink composition, in particular an ink composition for use in inkjet printing, such as continuous inkjet printing.

### BACKGROUND OF THE INVENTION

In the field of industrial coding and marking codes, dating and traceability information are applied directly onto products and/or packaging. A commonly used technique is continuous inkjet printing in which the selective charging and deflection of droplets of ink are used to mark a wide variety of substrates.

It is common in food packaging applications for the final packed and printed product to undergo an additional processing step before it reaches the consumer to extend the shelf life of the product, examples of such processes are deep freezing, retorting or sterilisation.

In the food packaging industry, printed substrates often go through a retort (or steam sterilisation process) to both sterilise packaging and partially cook the contents of the packaging. As the packaging may be in contact with adjacent packaging there is a possibility for the printed code to transfer or ‘offset’ to the adjacent packaging, especially at the high temperatures of the retort process. In order for the code to not transfer, the dried ink must remain hard and non-tacky at high temperature.

Some known approaches for providing inks that are stable under retort conditions are discussed in CN 101987932A, CN 101987931A and CN 102140276A. There is no disclosure that the inks in these applications are resistant to offsetting during retort.

CN 101987932A discusses an inkjet ink composition having a one or more organic solvents, resins and colourants with a viscosity of 2.8 to 6.2 CP at 25° C., a conductivity of 500-1,500 ρS and a surface tension of 27-30 Dyn/cm at 20° C. The ink is described as being resistant to steam treatment.

CN 101987931A discusses an inkjet ink composition having 11-26 wt % polymer resin, 2-10 wt % colourant, 65-75 wt % solvent, and 1-5 wt % antistatic agent. The ink is described as being resistant to fading upon high temperature baking.

CN 102140276A discusses an inkjet ink composition having a one or more organic solvents, resins, colourants and adjuvants characterised by having a polyurethane as the main binder. The ink has a viscosity of 2 to 10 CP at 25° C., a conductivity of 500-2,000 ρS and a surface tension of 27-35 Dyn/cm at 20° C. The ink is described as being resistant to steam treatment.

It is desirable for prints to be durable, have good adhesive and rub resistance properties as well as good contrast on the substrate. Inks having these properties are desirable for use in food packaging applications due to their fast dry time, their ability to produce legible marks on non-uniform surfaces and their ability to have good adhesion on a wide variety of packaging types.

It is also desirable for ink formulations used in coding and marking to have good thermal stability properties so that the physical properties (such as viscosity and particle size) do not change significantly either during the storage of ink or during operation in the printer. This thermal stability (in both hot and cold environments) is required to ensure reliable printer running so that acceptable print quality and on-substrate performance in all customer environments can be assured.

It is an object of the present invention to provide an ink composition that has some of the above desirable characteristics. In particular, it is an object of the invention to provide an ink which survives the retort process and do not transfer to adjacent packaging during the process.

It is an alternative and/or additional object of the present invention to overcome or address the problems of prior art inkjet ink compositions or to at least provide a commercially useful alternative thereto.

### SUMMARY OF THE INVENTION

The present invention seeks to provide a solvent-based ink composition, in particular an ink composition for use in inkjet printing such as continuous inkjet printing, which is suitable for producing durable codes on substrates which undergo industrial retort and sterilisation processes. The present invention may also provide thermal stability and reliability in the printer.

Accordingly, in one aspect the present invention provides an ink composition comprising one or more volatile organic solvents and one or more colourants. The inkjet ink composition includes a binder resin comprising one or more polymers and a metal crosslinker for cross linking the polymers of the binder resin. The one or more polymers contain coordinating groups for cross linking the polymers of the main binder resin with the metal crosslinker. The coordinating group content is from 1.7 to 28 wt % based on the total weight of the main binder resin. Preferably, the main binder resin is present in at least 1.5 wt % based on total weight of the ink composition.

In another aspect the present invention provides a printed deposit formed from the ink composition of the invention. The printed deposit comprises one or more colourants and includes a binder resin comprising one or more polymers and a metal crosslinker which crosslinks the polymers of the binder resin.

In this way the present invention provides an ink composition and/or printed deposit which can survive retort processes without offsetting onto adjacent products.

The ink composition may further comprise a carboxyl resin for reducing the viscosity of the ink composition. The ink composition may further comprise a third binder resin for increasing the resolubility of the ink composition. Typically the third binder is present together with the carboxyl resin.

In this way the present invention provides an ink which has desirable durability properties coupled with good thermal stability and printer reliability.

The ink composition is compatible with the components of an inkjet printer, and more particularly a continuous inkjet printer. The ink composition is suitable for application directly onto products and/or product packaging to achieve high quality images.

These and other aspects and embodiments of the invention are described in further detail below.

### SUMMARY OF THE FIGURES

FIG. 1 is a plot of the jet stability tracking data for an ink composition of the invention (Ink 3) measured by tracking the movement of the printer jet from a top down perspective.

FIG. 2 is a plot of the jet stability tracking data for an ink composition of the invention (Ink 4) measured by tracking the movement of the printer jet from a top down perspective.

### DETAILED DESCRIPTION OF THE INVENTION

The present invention provides an ink composition including one or more volatile organic solvents and one or more colourants. The ink includes a main binder resin comprising one or more polymers and a metal crosslinker. The one or more polymers contain coordinating groups for cross linking the polymers of the main binder resin with the metal crosslinker. Typically the coordinating group content is from 1.7 to 28 wt % based on the total weight of the main binder resin.

Preferably the ink composition described herein has a viscosity of about 0.5 to 7 mPa·s, more preferably from 1 to 5.5 mPa·s at 25° C. Preferably the ink composition described herein has a viscosity of less than 7 mPa·s, more preferably less than 5.5 mPa·s at 25° C. Preferably the ink composition described herein has a viscosity of greater than 0.5 mPa·s, more preferably greater than 1 mPa·s, even more preferably greater than 3 mPa·s at 25° C.

The viscosity of the ink composition may be in a range with the upper and lower limits selected from the amounts described above. The viscosity of the composition may be measured using a viscometer such as a Brookfield DV-11+ viscometer.

Preferably the ink composition as described herein has a surface tension of from 20 to 50 mN/m, more preferably from 25 to 40 mN/m at 25° C. The surface tension of the composition may be measured using equipment such as a du Nouy ring tensiometer or using the pendant drop method on a KSV Cam 200 optical tensiometer.

Solvent

The ink composition contains at least one volatile organic solvent. Any volatile organic solvent which can dissolve the resins is suitable. The solvent may be selected from ketones, alcohols, esters, glycols, glycol ethers. The solvent may be a mixture of solvents.

The expression “volatile organic solvent” is generally understood to mean that this solvent has a speed of evaporation of more than 0.5 (preferably of more than 1.5, more preferably of more than 2) on the scale in which n-butyl acetate has a speed of evaporation equal to 1. In other words (see below), this solvent has a volatility index according to NF T30-301 standard of more than 0.5, preferably of more than 1.5, more preferably of more than 2. The speed of evaporation or volatility may be determined at a temperature of 25° C. at a pressure 1.013 kPa.

The volatile organic solvent provides short drying times due to quick evaporation of the organic solvent (for example, compared to aqueous solvents). The volatile organic solvent improves adhesion of the ink composition due to its ability to penetrate semi-porous or non-porous substrates. The drying time of the ink varies depending on the ambient temperature, pressure and humidity, such as at 25° C., 1.013 kPa and Q70% humidity. Preferably the ink dries in from 0.1 to 3 seconds.

For example, the volatile organic solvent may be selected from acetone, methyl ethyl ketone, methyl propyl ketone, methyl isobutyl ketone, cyclohexanone, ethanol, isopropanol, n-propanol, isobutanol, n-butanol, methyl acetate, ethyl acetate, n-propyl acetate, isopropyl acetate, n-butyl acetate, isobutyl acetate, t-butyl acetate, n-amyl acetate, isoamyl acetate, isobutyl isobutyrate, ethylene glycol, propylene glycol, 1-methoxy-2-propanol and 1-methoxy-2-propyl acetate.

In one embodiment, the volatile organic solvent is not an ester solvent.

The ink composition may also contain water. For example, if present, water may be present at less than 10 wt % based the total weight of the ink composition, preferably water is present at less than 5 wt %.

The composition may be a nonaqueous composition.

Preferably, the volatile organic solvent is present in the composition between 10 to 95 wt %, more preferably 40 to 90 wt %, and most preferably 70 to 90 wt % by weight based on total weight of the ink composition.

Preferably, the volatile organic solvent is present in less than 95 wt % based on total weight of the ink composition, more preferably less than 93 wt % and even more preferably less than 91 wt %. Preferably, the organic solvent is present in greater than 10 wt % based on total weight of the ink composition, preferably greater than 40 wt %, and even more preferably greater than 70 wt %. The solvent may be present in an amount that is in a range with the upper and lower limits selected from the amounts described above.

A preferred volatile organic solvent is a ketone, such as methyl ethyl ketone. Preferably, the ketone, such as methyl ethyl ketone, is present from 10 to 90 wt %, more preferably 50 to 85 wt %, and most preferably 65 to 80 wt % based on total weight of the ink composition.

Preferably, the ketone, such as methyl ethyl ketone, is present in less than 90 wt % based on total weight of the ink composition, more preferably less than 85 wt % and even more preferably less than 80 wt %. Preferably, the ketone, such as methyl ethyl ketone, is present in greater than 10 wt % based on total weight of the ink composition, preferably greater than 50 wt %, and even more preferably greater than 65 wt %. The ketone may be present in an amount that is in a range with the upper and lower limits selected from the amounts described above.

Preferably, when the volatile organic solvent is a mixture, the mixture contains an alcohol, such as a C₁₋₆ alkyl alcohol. For example, ethanol or isopropanol. Preferably, the alcohol is present from 5 to 20 wt %, more preferably 10 to 15 wt %, based on total weight of the ink composition.

Preferably, the alcohol is present in less than 20 wt % based on total weight of the ink composition, more preferably less than 15 wt %. Preferably, the alcohol is present in greater than 5 wt % based on total weight of the ink composition, preferably greater than 10 wt %. The alcohol may be present in an amount that is in a range with the upper and lower limits selected from the amounts described above.

Preferably when the volatile organic solvent is a mixture, the mixture comprises a ketone and an alcohol such as a C₁₋₆ alkyl alcohol. For example, the mixture comprises methyl ethyl ketone and ethanol or isopronanol.

In the printed deposit the solvent has at least partially evaporated. In this case, it may be that no solvent or only trace amounts of solvent are present in the printed deposit.

Colourant

The ink composition comprises a colourant, for example a dye or a pigment. Preferably the colourant is a pigment. The pigment may be in the form of a dispersion in the composition. The pigment may be an inorganic or an organic pigment.

Preferably the pigment has an average particle size of less than 1 μm. The average particle size referred to here is the Z average particle size calculated using dynamic light scattering. This is the intensity weighted mean hydrodynamic size of the collection of particles.

For example, the inorganic pigment may be selected from titanium oxides such as titanium dioxide, iron oxide and carbon blacks produced by known processes, such as contact, furnace, and thermal processes.

For example, the organic pigments may be selected from azo pigments (including azo lake, insoluble azo pigment, condensed azo pigment, and chelate azo pigment), polycyclic pigments (for example, phthalocyanine, perylene, perinone, anthraquinone, quinacridone, dioxazine, thioindigo, isoindolinone, and quinophthalone pigments), dye-type chelate pigment (for example, basic dye-type chelate pigments and acid dye-type chelate pigment), nitro pigments, nitroso pigments, and aniline black.

Preferably, the inorganic pigment is carbon black. Carbon blacks usable for black inks include carbon blacks manufactured by Mitsubishi Chemical Corporation, for example, No. 2300, No. 900, MCF 88, No. 33, No. 40, No. 45, No. 52, MA 7, MA 8, MA 100, and No. 2200 B; carbon blacks manufactured by Columbian Carbon Co., Ltd., for example, Raven 5750, Raven 5250, Raven 5000, Raven 3500, Raven 1255, and Raven 700; carbon blacks manufactured by Cabot Corporation, for example, Regal 400 R, Regal 330 R, Regal 660 R, Mogul L, Monarch 700, Monarch 800, Monarch 880, Monarch 900, Monarch 1000, Monarch 1100, Monarch 1300, and Monarch 1400; and carbon blacks manufactured by Degussa, for example, Color Black FW 1, Color Black FW 2, Color Black FW 2 V, Color Black FW 18, Color Black FW 200, Color Black S 150, Color Black S 160, Color Black S 170, Printex 35, Printex U, Printex V, Printex 140 U, Special Black 6, Special Black 5, Special Black 4A, and Special Black 4.

Pigments for yellow inks include C.I. Pigment Yellow 1, C.I. Pigment Yellow 2, C.I. Pigment Yellow 3, C.I. Pigment Yellow 12, C.I. Pigment Yellow 13, C.I. Pigment Yellow 14, C.I. Pigment Yellow 16, C.I. Pigment Yellow 17, C.I. Pigment Yellow 73, C.I. Pigment Yellow 74, C.I. Pigment Yellow 75, C.I. Pigment Yellow 83, C.I. Pigment Yellow 93, C.I. Pigment Yellow 95, C.I. Pigment Yellow 97, C.I. Pigment yellow 98, C.I. Pigment Yellow 109, C.I. Pigment Yellow 110, C.I. Pigment Yellow 114, C.I. Pigment Yellow 128, C.I. Pigment Yellow 129, C.I. Pigment yellow 138, C.I. Pigment Yellow 150, C.I. Pigment Yellow 151, C.I. Pigment Yellow 154, C.I. Pigment Yellow 155, C.I. Pigment Yellow 180, C.I. Pigment Yellow 185, and C.I. Pigment Yellow 139.

Pigments for magenta inks include C.I. Pigment Red 5, C.I. Pigment Red 7, C.I. Pigment Red 12, C.I. Pigment Red 48 (Ca), C.I. Pigment Red 48 8 (Mn), C.I. Pigment Red 57 (Ca), C.I. Pigment Red 57: 1, C.I. pigment Red 112, C.I. Pigment Red 122, C.I. Pigment Red 123, C.I. Pigment Red 168, C.I. Pigment Red 184, C.I. Pigment Red 202, C.I. Pigment Red 176, C.I. Pigment Red 254, C.I. Pigment Red 255, C.I. Pigment Red 272, C.I. Pigment Red 254, C.I. Pigment Orange 64, and C.I. Pigment Orange 73.

Pigments for cyan inks include C.I. Pigment Blue 1, C.I. Pigment Blue 2, C.I. Pigment Blue 3, C.I. Pigment Blue 15: 3, C.I. Pigment Blue 15: 34, C.I. Pigment Blue 16, C.I. Pigment Blue 22, C.I. Pigment Blue 60, C.I. Vat Blue 4, C.I. Vat Blue 60, C.I. Pigment Blue 15:2, C.I. Pigment Blue 15:4, C.I. Pigment Green 3, C.I. Pigment Violet 23 and C.I. Pigment Violet 37.

Preferably, the organic pigment is selected from C.I. Pigment Red 176, C.I. Pigment Red 254, C.I. Pigment Red 255, C.I. Pigment Red 272, C.I. Pigment Red 254, C.I. Pigment Orange 64, C.I. Pigment Orange 73, C.I. Pigment Yellow 83, C.I. Pigment Yellow 138, C.I. Pigment Yellow 139, C.I. Pigment Yellow 151, C.I. Pigment Yellow 154, C.I. Pigment Blue 15:2, C.I. Pigment Blue 15:3, C.I. Pigment Blue 15:4, C.I. Pigment Green 3, C.I. Pigment Violet 23 and C.I. Pigment Violet 37.

Preferably the colourant is present in between 1 to 25 wt % based on total weight of the ink composition, more preferably 1.5 to 15 wt %, and most preferably 2 to 6 wt % based on total weight of the ink composition.

Preferably, the colourant is present in less than 25 wt % based on total weight of the ink composition, more preferably less than 15 wt % and even more preferably less than 4 wt %. Preferably, the colourant is present in greater than 1 wt % based on total weight of the ink composition, preferably greater than 1.5 wt %, and even more preferably greater than 2 wt %. The colourant may be present in an amount that is in a range with the upper and lower limits selected from the amounts described above.

In this way the formulation may have the desired opacity and colour.

Metal Crosslinker

The metal crosslinker contains a metal species that can form a crosslink between polymers of the main binder resin. The metal species of the metal crosslinker may form a crosslink between the polymers of the carboxyl resin and/or the third resin, where such are present. Any suitable metal species can be used for this purpose.

Preferably the metal crosslinker is a titanium or zirconium containing species, preferably a Ti(IV) or Zr(IV) containing species. A metal cross linking agent may be used which in solution reacts to form a cross link between two or more polymers using the metal in the metal cross linking agent.

The metal crosslinking agent may be a metal ligand complex, for example a metal cation with an organic ligand. Preferably the ligand of the metal ligand complex is an organic ligand such as an alkylcarboxylate. Preferably, the metal of the metal ligand complex is a metal cation, such as Ti(IV) or Zr(IV). For example, the metal crosslinker agent may be selected from titanium acetylacetonate, titanium butylphosphate, titanium triethanolamine, titanium lactate, zirconium diethylcitrate, zirconium acetate, and zirconium propionate. Preferably, the metal crosslinker is zirconium propionate.

Preferably, the metal crosslinker agent is added in from 0.1 to 5 wt %, more preferably 0.3 to 4 wt %, and most preferably 0.7 to 3 wt % based on total weight of the ink composition.

Preferably, the metal crosslinker agent is added in less than 5 wt % based on total weight of the ink composition, more preferably less than 4 wt % and even more preferably less than 3 wt %. Preferably, the metal crosslinker agent is added in greater than 0.1 wt % based on total weight of the ink composition, preferably greater than 0.3 wt %, and even more preferably greater than 0.7 wt %. The metal crosslinker agent may be present in an amount that is in a range with the upper and lower limits selected from the amounts described above.

Without wishing to be bound by theory it is believed the metal centre crosslinks some of the polymers of the main binder resin by interacting with the polymer through coordinating groups on the polymer. Examples of coordinating groups are hydroxyl, carboxyl and amino. In this way, the metal crosslinker gives the ink its high temperature resistance properties as well as resistance to offsetting during the retort process.

At least some crosslinking may occur in the liquid ink, however, it is preferable that full crosslinking occurs only when the solvent evaporates. The solvent evaporation increases the concentration of the components and will increase the rate of crosslinking. Full crosslinking in the liquid ink may lead to gelling of the ink.

In some cases, at least some of the polymers of the main binder resin are crosslinked by the metal crosslinker in the organic solvent.

Main Binder Resin

The ink composition contains a main binder resin. The main binder resin comprises one or more polymers. One or more polymers of the main binder resin are crosslinkable by the metal crosslinker. The crosslinking occurs via one or more suitable coordinating groups on the polymers of the main binder resin.

The coordinating group content is from 1.7 to 28 wt % based on the total weight of the main binder resin, more preferably the coordinating group content is from 2 to 22 wt % and even more preferably from 3 to 17 wt %. Preferably, the coordinating group content is less than 28 wt % based on the total weight of the main binder resin, more preferably less than 22 wt % and even more preferably less than 17 wt %. Preferably, the coordinating group content is greater than 1.7 wt % based on the total weight of the main binder resin, preferably greater than 2 wt %, and even more preferably greater than 3 wt %. The coordinating group content of the main binder resin may be in a range with the upper and lower limits selected from the amounts described above.

For example, the polymers of the main binder resin may have one or more of the following coordinating groups which are capable of binding the metal crosslinker; hydroxyl, carboxyl and amino.

As discussed above, the crosslinking of the main binder resin and the metal crosslinker gives the ink its high temperature resistance properties as well as resistance to offsetting during the retort process.

Additionally, the main binder resin may impart desirable viscosity and adhesion properties to the ink.

Without wishing to be bound by theory, it is proposed that the main binder resin provides viscosity by chain entanglement which causes the solution to resist flow. The adhesion can be brought by several mechanisms: entanglement with the substrate upon drying, intermingling of polymer chains, and physical interactions such as hydrogen bonding and dipole interactions between the polymer and substrate.

In one embodiment, the polymers of the main binder resin have hydroxyl groups for coordination with the metal crosslinker.

Preferably the hydroxyl number is from 60 to 330 mg KOH/g, more preferably 100 to 265 mg KOH/g, and most preferably 130 to 200 mg KOH/g. Preferably the hydroxyl number is less than 330 mg KOH/g, more preferably less than 265 mg KOH/g, and most preferably less than 200 mg KOH/g. Preferably the hydroxyl number is greater than 60 mg KOH/g, more preferably greater than 100 mg KOH/g, and most preferably greater than 130 mg KOH/g. The hydroxyl number of the main binder resin may be in a range with the upper and lower limits selected from the amounts described above.

The hydroxyl number is the number of milligrams of potassium hydroxide required to neutralize the acetic acid taken up on acetylation of one gram of a chemical substance that contains free hydroxyl groups.

Preferably the hydroxyl content is from 2 to 10 wt % based on the total weight of the main binder resin, more preferably the hydroxyl content is from 3 to 8 wt % and even more preferably from 4 to 6 wt %. Preferably, the hydroxyl content is less than 10 wt % based on the total weight of the main binder resin, more preferably less than 8 wt % and even more preferably less than 6 wt %. Preferably, the hydroxyl content is greater than 2 wt % based on the total weight of the main binder resin, preferably greater than 3 wt %, and even more preferably greater than 4 wt %. The hydroxyl number of the main binder resin may be in a range with the upper and lower limits selected from the amounts described above. The hydroxyl content of the main binder resin may be an amount that is in a range with the upper and lower limits selected from the amounts described above.

The hydroxyl content expressed in weight percent refers to the weight percent (wt %) of hydroxyl groups in units of the mass of hydroxide functional groups in grams per 100 grams of substance.

In one embodiment, the polymers of the main binder resin have amine groups for coordinating with the metal crosslinker.

Preferably the amine number is from 20 to 330 mg KOH/g, more preferably 30 to 265 mg KOH/g, and most preferably 60 to 200 mg KOH/g. Preferably the amine number is less than 330 mg KOH/g, more preferably less than 265 mg KOH/g, and most preferably less than 200 mg KOH/g. Preferably the amine number is greater than 20 mg KOH/g, more preferably greater than 30 mg KOH/g, and most preferably greater than 60 mg KOH/g. The amine number of the main binder resin may be in a range with the upper and lower limits selected from the amounts described above.

The amine number is the number of milligrams of potassium hydroxide required to neutralize the acetic acid taken up on acetylation of one gram of a chemical substance that contains free amine groups.

In one embodiment, the polymers of the main binder resin have carboxyl groups for coordinating with the metal crosslinker.

Preferably, the main binder resin has an acid number of 60 to 500 mg KOH/g, more preferably 100 to 500 mg KOH/g, more preferably 130 to 500 mg KOH/g, and most preferably 200 to 500 mg KOH/g. Preferably the acid number is less than 500 mg KOH/g, more preferably less than 450 mg KOH/g, and most preferably less than 400 mg KOH/g. Preferably the acid number is greater than 60 mg KOH/g, more preferably greater than 100 mg KOH/g, more preferably greater than 130 mg KOH/g, and most preferably greater than 200 mg KOH/g. The acid number of the main binder resin may be in a range with the upper and lower limits selected from the amounts described above.

Acid number is measured by titrating 1 g of the material with potassium hydroxide until the neutralisation point. The acid number is the amount of KOH in milligram (mg) required to reach the neutralisation point.

The main binder resin may be selected from any suitable binder resin, for example, suitable binders include polyamide resins, polyurethane resins, rosin ester resins, acrylic resins, polyvinyl butyral resins, polyesters, phenolic resins, vinyl resins, polystyrene/polyacrylate copolymers, cellulose ethers, cellulose nitrate resins, polymaleic anhydrides, acetal polymers, polystyrene/polybutadiene copolymers, polystyrene/polymethacrylate copolymers, sulfonated polyesters, aldehyde resins, polyhydroxystyrene resins and polyketone resins and mixtures of two or more thereof.

Preferably, the main binder resin is selected from cellulosic resins, acrylic resins, vinyl resins, polyamides, polyesters and polyurethanes. More preferably, the main binder resin is a cellulosic resin. Even more preferably, the cellulosic resin is cellulose acetate butyrate.

Preferably, the main binder resin has a molecular weight, such as a weight average molecular weight (Mw) between 1,500 and 50,000, more preferably between 10,000 and 50,000 and even more preferably between 15,000 and 50,000. Preferably, the main binder resin has a molecular weight, such as a weight average molecular weight (Mw) of at least 1,500, more preferably at least 10,000 and even more preferably at least 15,000.

Preferably, the main binder resin has a molecular weight, such as a weight average molecular weight (Mw) less than 50,000. The main binder resin has a molecular weight, such as a weight average molecular weight (Mw) that is in a range with the upper and lower limits selected from the amounts described above.

Preferably, the main binder resin has good solubility in the organic solvents commonly used in solvent based inks. For example, the solubility of the main binder resin the solvent is from 20 to 100 grams/100 mL at 25° C.

Preferably, the main binder resin is present at from 1.5 to 25 wt % based on total weight of the ink composition, more preferably from 2 to 10 wt % and even more preferably from 4 to 6 wt %.

Preferably, the main binder resin is present in less than 25 wt % based on total weight of the ink composition, more preferably less than 10 wt %, more preferably less than 8 wt % and even more preferably less than 6 wt %. Preferably, the main binder resin is present in greater than 1.5 wt % based on total weight of the ink composition, preferably greater than 2 wt %, and even more preferably greater than 4 wt %. The main binder resin may be present in an amount that is in a range with the upper and lower limits selected from the amounts described above.

Preferably, the main binder resin is present in the composition at an amount that is greater than the amount of the carboxyl resin, where present, and greater than the amount of the third resin, where present.

Preferably, the main binder resin has good solubility in the organic solvents commonly used in solvent based inks.

For example, the solubility of the main binder resin in the solvent is from 20 to 100 g/100 mL at 25° C.

A combination of different resins may provide the ink composition of the present invention, such as the combination of the resins mentioned above, i.e. a main binder resin, a carboxyl resin and a third resin.

In the printed deposit at least some of the polymers of the main binder resin are crosslinked by the metal crosslinker.

Carboxyl Resin

The ink composition may comprise a second resin, which is different to the main binder resin. The second resin is a carboxyl resin.

A carboxyl resin is a resin having carboxyl functional groups, that is, the resin contains one or more —COOH residues. Examples of suitable carboxyl resins are acrylic resins, rosin resins, and maleic resins. The carboxyl resin may be a polymer, for example, a polymer having carboxyl functional groups, that is, the polymer contains one or more —COOH residues

Without wishing to be bound by theory it is believed that the carboxyl groups interact preferentially with the metal crosslink agent to retard viscosity increase through crosslinking of the main binder resin. In this way the carboxyl resin imparts improved storage stability to the ink.

Preferably the carboxyl resin is a styrene maleic anhydride-based (SMA) polymer containing carboxyl functional groups.

The SMA based resin can be obtained, for example, by reacting polymeric styrene maleic anhydride with a suitable alcohol. This may be done during the formulation of the ink composition by adding styrene maleic anhydride and a suitable alcohol to the ink formulation. Suitable alcohols include ethanol, isopropanol, n-propanol, isobutanol, n-butanol and 1-methoxy-2-propanol.

Preferably, the carboxyl resin has an acid number of 60 to 500 mg KOH/g, more preferably 100 to 500 mg KOH/g, more preferably 130 to 500 mg KOH/g, and most preferably 200 to 500 mg KOH/g. Preferably the acid number is less than 500 mg KOH/g, more preferably less than 450 mg KOH/g, and most preferably less than 400 mg KOH/g. Preferably the acid number is greater than 60 mg KOH/g, more preferably greater than 100 mg KOH/g, more preferably greater than 130 mg KOH/g, and most preferably greater than 200 mg KOH/g. The acid number of the carboxyl resin may be in a range with the upper and lower limits selected from the amounts described above.

Acid number is measured by titrating 1 g of the material with potassium hydroxide until the neutralisation point. The acid number is the amount of KOH in milligram (mg) required to reach the neutralisation point.

For example, in the case where a styrene maleic anhydride resin is reacted with an alcohol, the alcohol reacts with the maleic anhydride group to form one ester group and one carboxyl group. This is sometimes referred to as the half ester (of the maleic anhydride). In this case, the acid number of an alcohol treated maleic anhydride is the number of milligrams of KOH required to neutralise the one carboxyl group formed by reaction with the alcohol, i.e. one molecule of KOH for each maleic anhydride group.

Additionally, for example, a styrene maleic anhydride has no carboxyl groups. However, a styrene maleic anhydride group does react with KOH. A maleic anhydride group reacts with two molecules of KOH (i.e. they react as if they were two carboxyl groups) to form the potassium salt. The acid number stated for such resins is the number of milligrams of KOH required to neutralise one gram of the resin in accordance with the definition of ‘acid number’. Therefore a styrene maleic anhydride still has an ‘acid number’ despite there being no carboxyl groups. The acid number of a styrene maleic anhydride will be two times the acid number required to neutralise the corresponding alcohol treated styrene maleic anhydride.

Preferably, the carboxyl resin is present at from 0.1 to 10 wt % based on total weight of the ink composition, more preferably from 0.5 to 5 wt % and even more preferably from 1 to 2 wt %.

Preferably, the carboxyl resin is present in less than 10 wt % based on total weight of the ink composition, more preferably less than 5 wt %, more preferably less than 3 wt % and even more preferably less than 2 wt %. Preferably, the carboxyl resin is present in greater than 0.1 wt % based on total weight of the ink composition, preferably greater than 0.5 wt %, and even more preferably greater than 1 wt %. The carboxyl resin may be present in an amount that is in a range with the upper and lower limits selected from the amounts described above.

Preferably, the polymers of the carboxyl resin have a molecular weight, such as a weight average molecular weight (Mw), between 1,500 and 50,000, more preferably between 2,000 and 20,000 and even more preferably between 4,000 and 10,000. Preferably, the polymers of the carboxyl resin have a molecular weight, such as a weight average molecular weight (Mw), of less than 50,000, more preferably less than 20,000 and even more preferably less than 10,000. Preferably, the polymers of the carboxyl resin have a molecular weight, such as a weight average molecular weight (Mw), of at least 1,500, more preferably at least 2,000 and even more preferably at least 4,000. The polymers of the carboxyl resin have a molecular weight, such as a weight average molecular weight (Mw) that is in a range with the upper and lower limits selected from the amounts described above.

Preferably the main binder contains polymer with a higher molecular weight than the polymers of the carboxyl resin. The higher molecular weight of the polymers of the main binder resin means crosslinking of the main binder resins increases the viscosity of the ink composition. The preferential crosslinking of carboxyl allows this increase in viscosity to be controlled which provides improved storage stability to the ink composition without affecting the retort resistance properties.

Preferably, the carboxyl resin has good solubility in the organic solvents commonly used in solvent based inks. For example, the solubility of the carboxyl resin in the solvent is from 20 to 100 grams/100 mL at 25° C. Preferably the solubility of the carboxyl resin is greater than 20 grams/100 mL at 25° C., more preferably the solubility is greater than 50 grams/100 mL at 25° C. The solubility of the carboxyl resin in the solvent may be in a range with the upper and lower limits selected from the amounts described above.

Third Resin

The ink composition may comprise a third resin. The third resin is different to the main binder resin, and is different to the carboxyl resin where such is present. The third binder resin improves the resolubility of the ink to impart reliable printer running.

The third binder resin may have a lower molecular weight, for example compared with the carboxyl resin, and it may have a lower molecular weight compared to the main binder resin.

Preferably, the third binder resin has a molecular weight, such as a weight average molecular weight (Mw), between 100 and 1,000, more preferably between 200 and 800 and even more preferably between 250 and 500. Preferably, the third binder resin has a molecular weight, such as a weight average molecular weight (Mw), of less than 1000, more preferably less than 800 and even more preferably less than 500. Preferably, the third binder resin has a molecular weight, such as a weight average molecular weight (Mw), of at least 100, more preferably at least 200 and even more preferably at least 250. The third binder resin has a molecular weight, such as a weight average molecular weight (Mw) that is in a range with the upper and lower limits selected from the amounts described above.

The low molecular weight of the third binder resin imparts resolubility to the ink composition.

Without wishing to be bound by theory it is proposed that if the low molecular weight third binder resin is non-coordinating it disrupts the crosslinking of the main binder resin by sitting between the polymer chains of the main binder resin. In this way, the third binder resin is believed to reduce the viscosity of the ink composition, thereby improving resolubility. Conversely, if the low molecular weight third binder resin is coordinating it can compete with the main binder resin and carboxyl resin to bind the metal crosslinker and reduce viscosity of the ink composition to improve the resolubility.

The third binder resin may contain carboxyl functional groups. Preferably, the third binder resin has an acid number of 60 to 500 mg KOH/g, more preferably 120 to 500 mg KOH/g, and most preferably 250 to 500 mg KOH/g. Preferably the acid number is less than 500 mg KOH/g, more preferably less than 450 mg KOH/g, and most preferably less than 400 mg KOH/g. Preferably the acid number is greater than 60 mg KOH/g, more preferably greater than 120 mg KOH/g, and most preferably greater than 200 mg KOH/g. The acid number of the third binder resin may be in a range with the upper and lower limits selected from the amounts described above.

Acid number is measured by titrating 1 g of the material with potassium hydroxide until the neutralisation point. The acid number is the amount of KOH in milligram (mg) required to reach the neutralisation point.

The third binder resin may compete with the carboxyl resin to coordinate with the metal crosslinker.

Without wishing to be bound by theory it is proposed that, if the third binder resin competes with the carboxyl resin to coordinate with the metal crosslinker, the crosslink density of the dried ink may be reduced. The reduced crosslink density of the dried ink may affect the retort resistance which it is proposed is provided by the cross-linking of the main binder resin. Preferably, low amounts of the third binder resin are used to balance the desired resolubility whilst maintain the retort resistance.

Preferably, the third binder resin is present at from 0.1 to 1 wt % based on total weight of the ink composition, more preferably from 0.3 to 0.9 wt % and even more preferably from 0.5 to 0.8 wt %.

Preferably, the third binder resin is present in less than 1 wt % based on total weight of the ink composition, more preferably less than 0.9 wt %, and even more preferably less than 0.8 wt %. Preferably, the third binder resin is present in greater than 0.1 wt % based on total weight of the ink composition, preferably greater than 0.3 wt %, and even more preferably greater than 0.5 wt %. The third resin may be present in an amount that is in a range with the upper and lower limits selected from the amounts described above.

The third binder resin may be a rosin resin. The rosin resin may be a hydrogenated rosin resin, a polymerised rosin resin, an ester of rosin resin, a phenolic modified rosin resin, or a maleic modified rosin resin. Preferably the rosin resin is a maleic modified rosin resin such as, for example, Erkamar 3360.

Preferably, the third resin has good solubility in the organic solvents commonly used in solvent based inks. For example, the solubility of the third resin in the solvent is from 1 to 100 grams/100 mL at 25° C.

Additives

The ink composition and the printed deposit may contain additional components, such as are common in the art.

Preferably, the ink composition and the printed deposit may further comprise one or more preservatives, humectants, surfactants, conductivity salts, wetting agents, adhesion promotion additives, biocides and mixtures of two or more thereof.

Conductivity Additives

Preferably, the ink composition and the printed deposit further comprise a conductivity additive. The conductivity additive may be any organic salt known in the art.

Conductivity additives for ink compositions are well-known in the art, in particular conductivity additives for ink compositions for inkjet inks are well known.

Preferably, the organic salt is selected from quaternary ammonium or phosphonium salts. For example, the organic salt may be selected from tetraethylammonium chloride, tetraethylammonium bromide, tetrabutylammonium chloride, tetrabutylammonium bromide, tetrabutylammonium acetate, tetrabutylammonium nitrate, tetrabutylammonium tetrafluoroborate, tetrabutylammonium hexafluorophosphate, tetrabutylphosphonium chloride and tetrabutylphosphonium bromide. A preferred salt is tetrabutylammonium bromide.

Preferably, the conductivity additive is present at from 0.1 to 5 wt % based on total weight of the ink composition.

Humectants

Preferably, the ink composition and the printed deposit further comprise a humectant.

Suitable humectants include ethylene glycol, 1,3-propanediol, 1,4-butanediol, 1,4-cyclohexanedimethanol, 1,5-pentanediol, 1,6-hexanediol, 1,8-octanediol, 1,2-propanediol, 1,2-butanediol, 1,3-butanediol, 2,3-butanediol, diethylene glycol, triethylene glycol, tetraethylene glycol, polyethylene glycol, dipropylene glycol, polypropylene glycol, glycerol, 1,2,6-hexanetriol, sorbitol, 2-pyrrolidone, 2-propanediol, butyrolacetone, tetrahydrofurfuryl alcohol and 1,2,4-butanetriol and mixtures of two or more thereof.

Preferably the humectant is selected from a group consisting of glycerol, tetrahydrofurfuryl alcohol, polypropylene glycol and mixtures of two or more thereof.

The ink composition may comprise approximately a 1:1 ratio of humectant to solvent.

The ink composition may comprise up to 30% by weight of humectants based on the total weight of the composition. More preferably, the ink composition comprises up to 20% by weight of humectants based on the total weight of the composition.

Preservatives

Preferably, the ink composition and/or the printed deposit further comprise a preservative.

Suitable preservatives include sodium benzoate, benzoic acid, sorbic acid, potassium sorbate, calcium sorbate, calcium benzoate, methylparaben and mixtures of two or more thereof. The preferred preservative is sodium benzoate.

The ink composition may comprise up to 2% by weight of preservative based on the total weight of the composition. More preferably, the ink composition comprises up to 1% by weight of preservative based on the total weight of the composition.

Surfactants

Preferably, the inkjet ink composition and/or the printed deposit further comprise a surfactant.

Suitable surfactants include anionic, cationic or non-ionic surfactants and mixtures of two or more thereof. Non-limiting examples of anionic surfactants include alkyl sulphate, alkylaryl sulfonate, dialkyl sulfonate, dialkyl sulphosuccinate, alkyl phosphate and polyoxyethylene alkyl ether sulphate. Non-limiting examples of cationic surfactants include alkylamine salt, ammonium salt, alkylpyridinium salt and alkylimidazolium salt. Non-limiting examples of non-ionic surfactants include polyoxyethylene alkyl ether, polyoxyethylene alkylaryl ether, sorbitan fatty acid ester, polyoxyethylene sorbitan fatty acid ester, polyoxyethylene sorbitol fatty acid ester, glycerine fatty acid ester, a fluorine-containing non-ionic surfactant and a silicon-containing non-ionic surfactant. Mixtures of two or more surfactants may be used. The ink composition may comprise up to 5% by weight of surfactant based on the total weight of the composition. More preferably, the ink composition comprises up to 1 wt % of surfactant based on the total weight of the composition.

Types of Packaging

The present disclosure further provides a method for printing images on a substrate comprising directing a stream of droplets of any of the embodiments of the ink composition of the invention onto the substrate and allowing the ink droplets to dry, thereby printing images on the substrate. Preferably, an inkjet printer such as a continuous inkjet printer is used in the method. Any suitable substrate may be printed in accordance with the invention.

The ink composition of the present invention is particularly suitable for printing on non-porous material, for example, non-porous materials used for food packaging.

Examples of suitable substrates include metalized cans, plastic pots, retort pouches, and flexible plastic films. These substrates can be made, for example, from aluminium, steel, LDPE, HDPE, polypropylene, PET, nylon or PVdC.

Methods and Uses

The ink compositions are formulated by combining the components using methods known in the art. The metal crosslinker additives described herein may be easily incorporated into existing formulation processes because the metal crosslinker additive is present in the ink composition in a relatively low amount. Therefore, the metal crosslinker additive preferably does not create solubility issues that require modifying existing formulation processes. Rather, the metal crosslinker additive is simply added to the ink compositions along with other components of the ink compositions. Since the metal crosslinker additives are easily incorporated into existing processes, the cost of reducing nozzle plate wetting and/or of increasing throw distance and/or of increasing decap time and/or of increasing retort resistance of an ink composition is low.

In some embodiments, the metal crosslinker is mixed with the carboxyl resin in the volatile organic solvent before addition of the main binder resin. For example, the carboxyl resin and the metal crosslinker may be mixed for around 12 to 24 hours before the main binder resin is added.

In this way, the viscosity of the ink produced is reliable. Without wishing to be bound by theory, it is proposed that the carboxyl resin crosslinks with the metal crosslinker and reaches an equilibrium point before the addition of the main binder resin. This might result in reduced crosslinking of the main binder resin and provides more reliable viscosity.

The present disclosure further provides a method for printing images on a substrate in a continuous inkjet printer comprising directing a stream of droplets of any of the embodiments of the ink composition to the substrate and allowing the ink droplets to dry, thereby printing images on the substrate. Any suitable substrate may be printed in accordance with the invention.

Examples of suitable substrates include porous substrates such as uncoated paper, semi-porous substrates such as aqueous coated paper, clay coated paper, silica coated paper, UV overcoated paper, polymer overcoated paper, and varnish overcoated paper, and non-porous substrates such as hard plastics, polymer films, polymer laminates, metals, metal foil laminates, glass, and ceramics. The paper substrates may be thin sheets of paper, rolls of paper, or cardboard. Plastics, laminates, metals, glass, and ceramic substrates may be in any suitable form such as in the form of bottles or containers, plates, rods, cylinders, etc.

Preferably, the ink composition as described herein is a food grade ink composition. Edible surfaces can be printed using the inks described herein. These foods include, without limitation, baked goods, biscuits and cakes, cookies, nuts, chocolates, cheeses, crackers and chips, and pastries, puddings and mousses, ice creams and creams, pet food and pet treats, main meal snacks, cereals, sausage casings and pharmaceutical tablets.

The ink composition of the present invention is of particular use for printing on egg shells. In the past providing high quality printing on egg shells has proved particularly difficult because of the curved shape of the egg and therefore the throw distance required is typically larger compared to printing on flat surfaces. Other difficulties encountered with providing high quality printing on egg shells include being able to provide an ink composition that has good water resistance, adhesion and contrast when printed onto the egg shell.

Advantageously, using the compositions and methods described herein overcomes and/or mitigates at least some of the problems described above, providing an improved quality print.

### Definitions

As used herein the term printed deposit refers to the ink composition after it has been printed onto a suitable substrate. That is the ink composition of the present invention wherein at least some of the solvent has evaporated.

As used herein the term ink composition includes an inkjet ink composition suitable for use in inkjet printing. The ink composition is typically in the form of a liquid, and typically a solution.

As used herein the terms retort, retorting or retort processing refer to an additional processing step used in the food packaging industry, typically these steps are intended to extend the shelf life of a product. The retort process is a steam treatment process which is employed to both sterilise the packaging and partially cook the contents of the packaging.

As used herein the term offsetting refers to the process whereby a code or the like printed on a packaging substrate is transferred to an adjacent substrate. Typically this occurs during the retort process and is typically an undesirable effect.

As used herein the term acid number refers to the amount of potassium hydroxide in milligrams that is needed to neutralize the acids in one gram of oil.

As used herein the term C₁₋₆ alkyl alcohol refers to any solvent having at least one hydroxyl function group (—OH) and having between 1 and 6 carbon atoms.

As used herein the term polymer refers to any substance having a repeat unit and includes:

polysaccharides and its derivative for example cellulose and its derivatives; addition polymers such as acrylic resins or polyvinyl resins; condensation polymer, for example polyurethanes, polyamide and polyesters; and co-polymers wherein the repeat unit is formed of two or more different compounds, for example of styrene and maleic anhydride.

Other Preferences

Each and every compatible combination of the embodiments described above is explicitly disclosed herein, as if each and every combination was individually and explicitly recited.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

Certain aspects and embodiments of the invention will now be illustrated by way of example and with reference to the figures described above.

### EXAMPLES

The following non-limiting examples further illustrate the present invention.

Print samples were created using a Domino A-Series+ print sample rig fitted with either a 60 or 75 μm nozzle. These were taken on flexible food packaging substrates made of PET, Nylon, PVdC and polypropylene. These substrates have been obtained from food manufacturers who operate in this sector.

Assessment of the retort resistance properties was tested by printing on one substrate and sandwiching against a blank substrate between two stainless steel sheets held together by paper clips.

Viscosity was measured using the Brookfield DV-E viscometer fitted with a UL adaptor. The viscosity was measured with the sample warmed by a water bath at a temperature of 25° C. ata pressure of 1.013 kPa and humidity of 70%.

Filtration time was measured by measuring the length of time it takes to filter 15 mL of ink through a 1 μm glass fibre filter.

Conductivity was measured using an EDT series 3 BA 380 conductivity meter using an EDT E8070 Polymer Conductivity Cell probe. The conductivity was measured with the sample warmed by a water bath at a temperature of 25° C.

### Example 1—Ink Compositions

Example and comparative ink compositions were formulated with the amounts listed in Table 1. Inks 1 to 4 are examples of the invention, whilst inks 5 and 6 are comparative examples, which are provided for the helpful understanding of the invention.

TABLE 1
Ink Compositions
Table 1-Example and Comparative Inks

| | Level (wt %*) | | | | | |
|---|---|---|---|---|---|---|
| Component | Ink 1 | Ink 2 | Ink 3 | Ink 4 | Ink 5 | Ink 6 |
| Methyl ethyl | 76.4 | 75.2 | 70.7 | 71.45 | 77.15 | 72.5 |
| Ketone | | | | | | |
| Ethanol | 13.6 | 13.3 | 1.3 | 1.3 | 13.6 | 13.0 |
| Isopropanol | — | — | 12.5 | 12.5 | — | — |
| 1-methoxy-2- | — | — | 3.0 | 3.0 | — | — |
| propyl acetate | | | | | | |
| CAB 553-0.4 | 5.75 | 5.75 | 4.75 | 4.75 | 5.75 | 1.25 |
| CAB 551-0.01 | | | | — | — | 9.0 |
| Zirconium | 0.75 | 1.5 | 1.5 | 1.5 | — | 0.75 |
| propionate | | | | | | |
| Erkamar 3360 | — | 0.75 | 0.75 | — | — | — |
| SMA 1000 | — | — | 1.5 | 1.5 | — | — |
| Tetrabutyl- | 1.0 | 1.0 | 1.5 | 1.5 | 1.0 | 1.0 |
| ammonium | | | | | | |
| bromide | | | | | | |
| Carbon black | 2.5 | 2.5 | 2.5 | 2.5 | 2.5 | 2.5 |
| pigment | | | | | | |

*wt % based on the total weight of the ink composition

CAB 553-0.4 is a cellulose acetate butyrate product with a high hydroxyl content (4.8%) that is commercially available from Eastman.

CAB 551-0.01 is a cellulose acetate butyrate product with a low hydroxyl content (1.5%) that is commercially available from Eastman.

SMA 1000 is a styrene maleic anhydride copolymer and is commercially available from Cray Valley.

Erkamar 3360 is a maleic modified rosin resin product that is commercially available from Rokra Kraemar.

### Example 2—Retort Processing

When printed on common flexible packing materials, it was found that the printed codes did not offset during the retort process.

This was tested by printing each of the example inks produced in Example 1 (above) on one substrate of each type (PET pouch, PVdC sheath, Nylon film and Polypropylene pouch). Each of the printed substrate was then sandwiched against a blank substrate and held between two stainless steel sheets held together by paper clips.

The substrates were then subjected to retort processing. The substrates were placed in an autoclave and heated for 22 minutes at 121° C. at 1.05 bar pressure.

The example ink compositions are rated 1-5 on offset resistance during the retort process, where 1 denotes complete transfer of the code to the blank substrate sandwiched thereto and 5 denotes no transfer of the code to the blank substrate sandwiched thereto.

TABLE 2
Retort Resistance of Example and Comparative Inks
Table 2-Retort resistance of example Inks

| | Ink 1 | Ink 2 | Ink 3 | Ink 4 | Ink 5 | Ink 6 |
|---|---|---|---|---|---|---|
| PET pouch | 5 | 5 | 5 | 5 | 2 | 1 |
| PVdC sheath | 5 | 5 | 5 | 5 | 3 | 2 |
| Nylon film | 5 | 5 | 5 | 5 | 2 | 2 |
| Polypropylene | 5 | 5 | 5 | 5 | 1 | 1 |
| pouch | | | | | | |

Example Inks 1 to 4 survived the retort process without showing any sign of code transfer to the blank substrate sandwiched thereto.

Example Ink 5 has no zirconium propionate and shows poor retort resistance with code transfer on all four substrates tested.

Example Ink 6 also shows poor retort resistance with code transfer on all four substrates tested. The main binder of Ink 6 is CAB 551-0.01, a cellulose acetate butyrate product with a low hydroxyl content (1.5%). Ink 6 has a low amount of CAB 553-0.4 which is used to disperse the pigment.

Without wishing to be bound by theory it is proposed that the polymers of the CAB 553-0.4 binder are not free polymers in the ink solution because they are bound to the pigment. The main binder, CAB 551-0.01, does not have enough hydroxyl groups to be effectively crosslinked and hence Ink 6 has poor retort resistance.

### Example 3—Storage Properties

Each of the examples inks 1 to 3 composition produced in Example 1 (above) were stored at temperatures between 5 and 60° C. for 12 weeks. The viscosity of the samples was measured periodically during this time.

The results of these measurements are shown below in table 3.

TABLE 3
Viscosity Measurements
Viscosity measured as a function of time

| | Storage | | | |
|---|---|---|---|---|
| | Temperature | Viscosity (cP) | | |
| Weeks | (° C.) | Ink 1 | Ink 2 | Ink 3 |
| 0 | 25 | 5.12 | 4.64 | 5.05 |
| 2 | 5 | 5.02 | 4.69 | 5.71 |
| | 25 | 5.34 | 4.76 | 5.85 |
| | 45 | 6.27 | 5.24 | 5.48 |
| | 60 | 7.40 | 5.80 | 5.18 |
| 4 | 5 | 5.03 | 4.70 | 5.61 |
| | 25 | 5.37 | 4.7 | 5.67 |
| | 45 | 6.37 | 5.52 | 5.18 |
| | 60 | 7.67 | 6.08 | 4.98 |
| 8 | 5 | 5.38 | 4.77 | 6.01 |
| | 25 | 5.41 | 4.87 | 5.88 |
| | 45 | 6.54 | 6.24 | 5.31 |
| | 60 | 8.28 | 6.63 | 5.33 |
| 12 | 5 | Abandoned | 4.78 | 6.01 |
| | 25 | Abandoned | 4.96 | 5.70 |
| | 45 | Abandoned | 6.60 | 5.39 |
| | 60 | gelled | 7.12 | 5.48 |

Vast differences were seen in their viscosities. In the case of Ink 1, the ink had gelled in the bottle after 12 weeks.

Ink 3 had a marked improvement in viscosity stability. The net increase was less than 1 cP and did not increase further between 8 and 12 weeks.

In contrast, Ink 1 and Ink 2 increased by 3.16 and 2.48 cP respectively.

This would give Ink 3 more reliable printer performance compared to formulations which have greater increases in viscosity.

### Example 4—Jet Stability

The jet stability of Example Inks 3 and 4 was measured by tracking the movement of the printer jet from a top down perspective. A Domino A-series A420i printer was used and the movement was tracked for 24 hours. The tracking was carried out using two cameras tracking the jet position in the X and Y plane.

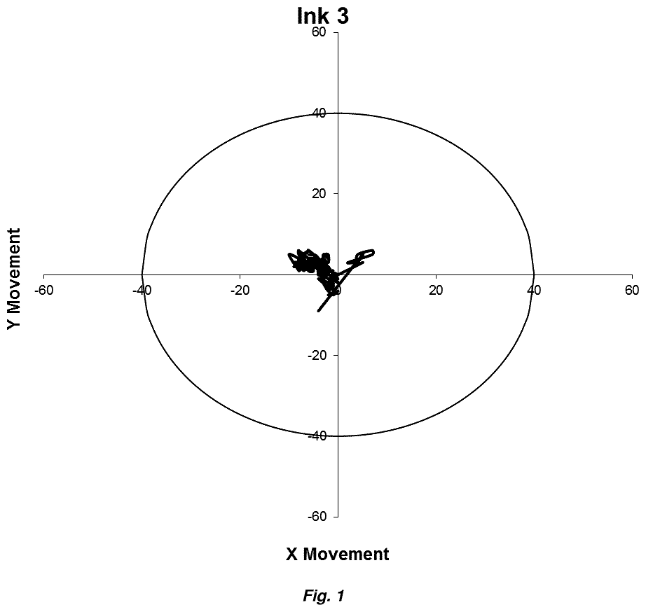

FIG. 1 shows the jet stability tracking for Ink 3.

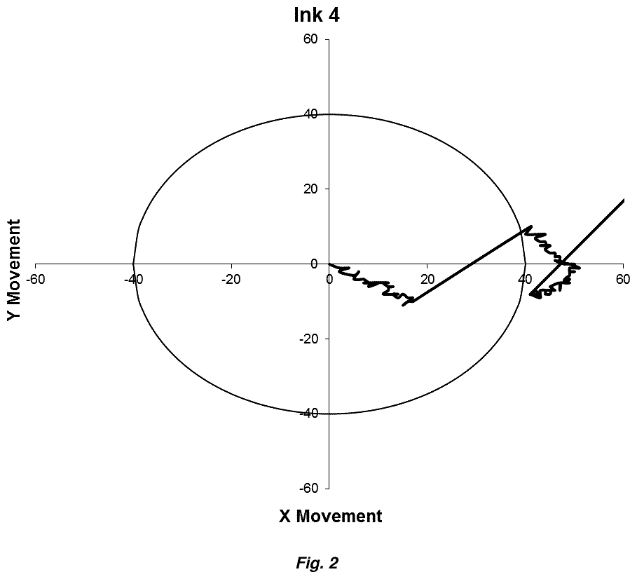

FIG. 2 shows the jet stability tracking for Ink 4.

Ink 4 does not contain Erkamar 3360 or any equivalent resin. It can be seen that the jet is far more stable for Ink 3 which includes Erkamar 3360 compared to Ink 4.

Without wishing to be bound by theory it is proposed that in Ink 4 non-dissolvable material builds up in the nozzle which deflects the jet away from the desired position. In Ink 3, the Erkamar 3360 aids solubility and prevent the build-up of non-dissolvable material.

1. An ink composition including one or more volatile organic solvents and one or more colorants, a main binder resin comprising one or more polymers, a second resin and a metal crosslinker, wherein the one or more polymers contain hydroxyl groups for crosslinking the polymers of the main binder resin with the metal crosslinker, the hydroxyl group content is from 1.7 to 28 wt % based on the total weight of the main binder resin, the main binder resin is present in at least 1.5 wt % based on total weight of the ink composition, and the second resin is different from the main binder resin and is a carboxyl resin, characterized in that the ink composition further comprises a third resin that is different from the main binder resin and the carboxyl resin and contains carboxyl functional groups.

2. The ink composition of claim 1, wherein the hydroxyl group content is from 2 to 22 wt %.

3-6. (canceled)

7. The ink composition of claim 1, wherein the main binder resin is a cellulosic resin.

8. The ink composition of claim 7, wherein the cellulosic resin is cellulose acetate butyrate.

9. (canceled)

10. The ink composition of claim 1, wherein the main binder resin is present at 1.5 to 25 wt % based on total weight of the ink composition.

11. The ink composition of claim 1, wherein the metal crosslinker is a titanium or zirconium containing species.

12. (canceled)

13. The ink composition of claim 11, wherein the metal crosslinker is zirconium propionate.

14. The ink composition of claim 1, wherein the metal crosslinker agent is provided at 0.1 to 5 wt %.

15. (canceled)

16. The ink composition of claim 1, wherein the carboxyl resin is a styrene maleic anhydride-based (SMA) polymer containing carboxyl functional groups.

17. The ink composition of claim 1, wherein the carboxyl resin has an acid number of 60 to 500 mg KOH/g.

18. The ink composition of claim 1, wherein the carboxyl resin is present at 0.1 to 10 wt % based on the total weight of the ink composition.

19. (canceled)

20. The ink composition of claim 1, wherein the main binder contains a polymer having a higher molecular weight, such as a higher weight average molecular weight, than the polymers of the carboxyl resin.

21. The ink composition of claim 1, wherein the main binder resin is present in the composition at an amount that is greater than the amount of the carboxyl resin.

22. (canceled)

23. The ink composition of claim 1, wherein the third binder resin has a lower molecular weight, such as a lower weight average molecular weight, than the carboxyl resin.

24-26. (canceled)

27. The ink composition of claim 1, wherein the third binder resin has an acid number of 60 to 500 mg KOH/g.

28. The ink composition of claim 1, wherein the third binder resin is present at 0.1 to 1 wt % based on total weight of the ink composition.

29. The ink composition of claim 1, wherein the third binder resin is a rosin resin.

30. (canceled)

31. The ink composition of claim 29, wherein the rosin resin is a maleic modified rosin resin.

32. (canceled)

33. A printing method comprising the steps of providing a composition according to claim 1, and depositing the ink composition onto a substrate, and optionally permitting the deposited composition to dry.

34-35. (canceled)

36. A substrate comprising a printed deposit produced by the method defined in claim 33.

37. (canceled)
